(19) United States
(12) Patent Application Publication
(10) Pub. No.: US 2016/0104897 A1
(43) Pub. Date: Apr. 14, 2016

(54) ELECTRODE CATALYST

(71) Applicant: TOYOTA JIDOSHA KABUSHIKI KAISHA, Toyota-shi (JP)

(72) Inventor: Iwao NITTA, Susono-shi (JP)

(21) Appl. No.: 14/856,071

(22) Filed: Sep. 16, 2015

(30) Foreign Application Priority Data
Oct. 9, 2014 (JP) 2014-208370

(51) Int. Cl. H01M 4/90

(52) U.S. Cl. CPC H01M 4/9083

(57) ABSTRACT

An electrode catalyst includes a carbon (C) carrier; a perovskite-type oxide catalyst containing lanthanum (La), manganese (Mn), and oxygen (O) elements; and a metal catalyst containing a silver (Ag) element. The perovskite-type oxide catalyst is located on the carrier and the metal catalyst is also located on the carrier.

### BACKGROUND OF THE INVENTION

1. Field of the Invention

The present invention relates to an electrode catalyst.

2. Description of the Related Art

An air battery is known as a means for storing and effectively using electrical energy. An air battery is characterized by capable of having large energy density in principle because a cathode (positive electrode) active material does not need to be arranged in a battery case and an anode (negative electrode) active material can be arranged in the most of the battery case. In other words, an air battery can increase the capacity and therefore is attracting attention.

An electrode catalyst that oxidizes/reduces oxygen is used for an air electrode of an air battery, which is an electrode catalyst manufactured by a reverse-micelle method and is disclosed in Patent Literature 1, for example. This electrode catalyst includes a C (carbon) carrier; and a perovskite-type oxide catalyst located on the carrier and containing La, Mn and O elements. This electrode catalyst is used as a fuel battery, a metal-air battery and the like for oxygen reduction.

### CITATION LIST

### Patent Literature 1

Japanese Laid-open Patent Publication No. 2003-288905

### SUMMARY OF INVENTION

However, when the electrode catalyst as disclosed in Patent Literature 1 is used as an air electrode of an air battery, carrier carbon is oxidatively decomposed at the time of discharge of the air battery, i.e., in an oxygen reduction reaction on the air electrode. Accordingly, the oxygen reduction reaction does not easily occur, and oxygen reduction reaction activity is decreased. On the other hand, an electrode catalyst having higher oxygen reduction reaction activity is necessary to improve performance of the air battery. An electrode catalyst having higher oxygen reduction reaction activity, in which carrier carbon is not oxidatively decomposed in an oxygen reduction reaction, is desired.

According to the present invention, an electrode catalyst including a C (carbon) carrier; a perovskite-type oxide catalyst located on the carrier and containing La, Mn and O elements; and a metal catalyst located on the carrier and containing a Ag element, is provided.

According to the present invention, an electrode catalyst having higher oxygen reduction reaction activity, in which carrier carbon is not oxidatively decomposed in an oxygen reduction reaction, can be obtained.

### BRIEF DESCRIPTION OF DRAWINGS

FIG. 1 is a graph illustrating a comparison of oxygen reduction reaction currents between Examples and Comparative Examples;

FIG. 2 is a graph illustrating a CV measurement result of an electrode catalyst of Example 1;

FIG. 3 is a photograph illustrating a TEM observation result of the electrode catalyst of Example 1;

FIG. 4 is a diffraction pattern illustrating an XRD measurement result of the electrode catalyst of Example 1;

FIG. 5 is a graph illustrating a CV measurement result of an electrode catalyst of Example 2;

FIG. 6 is a photograph illustrating a TEM observation result of the electrode catalyst of Example 2;

FIG. 7 is a diffraction pattern illustrating an XRD measurement result of the electrode catalyst of Example 2;

FIG. 8 is a graph illustrating a CV measurement result of an electrode catalyst of Example 3;

FIG. 9 is a photograph illustrating a TEM observation result of the electrode catalyst of Example 3;

FIG. 10 is a graph illustrating a CV measurement result of an electrode catalyst of Comparative Example 1;

FIG. 11 is a photograph illustrating a TEM observation result of the electrode catalyst of Comparative Example 1;

FIG. 12 is a graph illustrating a CV measurement result of an electrode catalyst of Comparative Example 2;

FIG. 13 is a photograph illustrating a TEM observation result of the electrode catalyst of Comparative Example 2;

FIG. 14 is a graph illustrating a CV measurement result of an electrode catalyst of Comparative Example 3;

FIG. 15 is a photograph illustrating a TEM observation result of the electrode catalyst of Comparative Example 3;

FIG. 16 is a graph illustrating a CV measurement result of an electrode catalyst of Comparative Example 4; and

FIG. 17 is a graph illustrating TG-DTA measurement results in air calcination of Examples and Comparative Examples.

### DESCRIPTION OF EMBODIMENTS

In the present embodiment, an electrode catalyst including a C (carbon) carrier; a perovskite-type oxide catalyst located on the carrier and containing La, Mn and O elements; and a metal catalyst located on the carrier and containing a Ag element, is provided. The perovskite-type oxide catalyst is an oxide catalyst having a perovskite phase as a crystalline phase.

The inventor has conducted a study on an electrode catalyst including a perovskite-type oxide catalyst using carbon as a carrier, and has obtained the following knowledge. An oxygen reduction reaction in the foregoing electrode catalyst, i.e., a 4-electron reduction reaction (O₂+2H₂O+4e⁻→4OH⁻) is composed of a first 2-electron reduction reaction (O₂+H₂O+2e⁻→HO₂⁻+OH⁻) which occurs initially and a second 2-electron reduction reaction (HO₂⁻+H₂O+2e⁻→3OH⁻) which occurs subsequently. The first 2-electron reduction reaction occurs mainly in the carrier carbon and the second 2-electron reduction reaction occurs mainly in the perovskite-type oxide catalyst. The reason why the oxygen reduction reaction does not sufficiently proceed and carrier carbon is oxidatively decomposed is that the first 2-electron reduction reaction is not sufficient or a reaction intermediate (OOH⁻) produced in the first 2-electron reduction reaction cannot sufficiently move to the second 2-electron reduction reaction but reacts with the carrier carbon.

By conducting extensive research on the basis of the foregoing knowledge, the inventor has succeeded in inventing a novel electrode catalyst in which a metal catalyst containing a Ag element is further added onto a carrier carbon in addition to a perovskite-type oxide catalyst containing La, Mn and O elements. This novel electrode catalyst can achieve improvement in ORR (Oxygen Reduction Reaction) activity and improvement in cycle durability as compared with the case where only the above-described perovskite-type oxide catalyst or only the above-described metal catalyst is supported on carbon.

The reason why advantageous effects, such as the improvement in ORR activity and the improvement in cycle durability, are achieved is thought to be due to the following mechanism. Firstly, oxygen and water are activated on the metal catalyst containing a Ag element, which has high oxygen dissociation capacity and water dissociation capacity, and the reaction intermediate (OOH⁻) is produced (first 2-electron reduction reaction). Subsequently, the reaction intermediate is effectively spilled over to the perovskite-type oxide catalyst containing La, Mn and O elements, which has high activity for reducing the reaction intermediate. Then, the reaction intermediate is reduced, which leads to the completion of the reaction (second 2-electron reduction reaction). At this time, a concerted reaction, in which these reactions proceed effectively, occurs and therefore high oxygen reduction reaction activity (first 2-electron reduction reaction+second 2-electron reduction reaction) is achieved on the whole. In this case, since the reaction intermediate (OOH⁻) produced in the first 2-electron reduction reaction is quickly moved to the second 2-electron reduction reaction, the oxidative decomposition of carrier carbon is suppressed.

As described above, according to the present embodiment, an electrode catalyst having higher oxygen reduction reaction activity, in which carrier carbon is not oxidatively decomposed in an oxygen reduction reaction, can be obtained.

Hereinafter, the electrode catalyst according to the present embodiment (hereinafter, also simply referred to as “present electrode catalyst”) will be described in detail.

### (Perovskite-Type Oxide Catalyst)

The perovskite-type oxide catalyst in the present electrode catalyst is located on carbon i.e., a carrier, and contains La, Mn and O elements. The perovskite-type oxide catalyst is not particularly limited as long as it is a material that has high activity for reducing the reaction intermediate (OOH⁻), i.e., a material that enables the above-described second 2-electron reduction reaction. For example, La that enters into the A-site of the perovskite-type structure may be partially or completely substituted with other rare earth elements and alkali earth metal elements. In addition, Mn that enters into the B-site of the perovskite-type structure may be partially or completely substituted with other 3d transition metal elements (Ti, V, Cr, Fe, Co, Ni). Among them, LaMnO₃ is preferable. In any case, inevitable impurities and dopants that do not cause an adverse impact on the above-described characteristics may be contained.

The ratio of the perovskite-type oxide catalyst with respect to the whole electrode catalyst (carrier carbon+perovskite-type oxide catalyst+metal catalyst), i.e., the carried amount of the perovskite-type oxide catalyst is 5 to 95 mass %, preferably 30 to 60 mass % and more preferably 40 to 50 mass %. When the carried amount of the perovskite-type oxide catalyst is too much, since carrier carbon and the metal catalyst become insufficient, the electron conductivity is decreased and the first 2-electron reduction reaction becomes difficult to occur. In contrast, when the carried amount of the perovskite-type oxide catalyst is too little, since the first 2-electron reduction reaction occurs but the second 2-electron reduction reaction does not sufficiently occur, carrier carbon is oxidized and decomposed by the attack of a peroxide (OOH⁻or the like) i.e., a reaction intermediate produced in the first 2-electron reduction reaction. Thus, the durability of the electrode catalyst is decreased and the reaction rate is decreased.

The particle diameter of the perovskite-type oxide catalyst is not particularly limited as long as the perovskite-type oxide catalyst has high activity for reducing the reaction intermediate, i.e., enables the above-described second 2-electron reduction reaction. The particle diameter of the perovskite-type oxide catalyst is preferably 1 to 30 nm, and more preferably 2 to 20 nm. When the particle diameter is too small, the activity is decreased due to sintering during the reaction process. When the particle diameter is too large, the reaction area is decreased and high activity cannot be obtained.

### (Metal Catalyst)

The metal catalyst in the present electrode catalyst is located on carbon i.e., a carrier, and contains a Ag element. The metal catalyst is not particularly limited as long as it is a material having high oxygen dissociation capacity and water dissociation capacity, i.e., a material that enables the above-described first 2-electron reduction reaction. For example, the Ag element may be partially or completely substituted with an alloy containing a Ag element, at least one of platinum group elements and an alloy containing at least one of platinum group elements. Among them, Ag and Pt are preferable, and Ag is particularly preferable. In any case, inevitable impurities and dopants that do not cause an adverse impact on the above-described characteristics may be contained.

The ratio of the metal catalyst with respect to the whole electrode catalyst, i.e., the carried amount of the metal catalyst is 5 to 95 mass %, preferably 15 to 75 mass %, and more preferably 40 to 60 mass %. When the carried amount of the catalyst is too much as compared with the above range, since the perovskite-type oxide catalyst becomes insufficient, the second 2-electron reduction reaction becomes difficult to occur. In contrast, when the carried amount of the catalyst is too little, the first 2-electron reduction reaction does not sufficiently occur and carrier carbon is oxidatively decomposed, i.e., effects caused by adding the metal catalyst cannot be sufficiently obtained.

The particle diameter of the metal catalyst is not particularly limited as long as the metal catalyst has high activity for reducing the reaction intermediate, i.e., enables the above-described second 2-electron reduction reaction. The particle diameter of the metal catalyst is preferably 1 to 30 nm, and more preferably 2 to 20 nm.

### (Carrier Carbon)

The carrier carbon is not particularly limited. Examples of the carrier carbon in the present electrode catalyst include carbon black, activated carbon, a carbon nanofiber, a carbon nanotube, foreign element doped carbon, mesoporous carbon and VGCF (Vapor Grown Carbon Fiber). Preferably, ones having a high geometric specific surface area or a high electrochemical specific surface area, such as Vulcan (specific surface area: 242 m²/g) manufactured by Cabot Corporation, Ketjenblack (specific surface area: 1320 m²/g) manufactured by Lion Specialty Chemicals Co., Ltd., and C65 (specific surface area: 65 m²/g) manufactured by TIMCAL Graphite & Carbon which have a specific surface area of 65 m²/g or more, are exemplified and Ketjenblack is particularly preferable. In addition, the particle diameter of the carrier carbon is not particularly limited as long as the carrier carbon can support the above-described perovskite-type oxide catalyst and metal catalyst.

### (Configuration of Catalyst)

The electrode catalyst is formed such that the metal catalyst is supported on the surface of the carrier carbon and the perovskite-type oxide catalyst is supported on the surface of the carrier carbon. In other words, both the metal catalyst and the perovskite-type oxide catalyst are formed to be in contact with the carrier carbon. In other words, the electrode catalyst is formed such that the metal catalyst is not placed on the perovskite-type oxide catalyst supported on the surface of the carrier carbon. The reason is that the above-described first 2-electron reduction reaction in the above-described 4-electron reduction reaction occurs on the metal catalyst or the carrier carbon by electrons supplied from the carrier carbon. At that time, if the metal catalyst is on the perovskite-type oxide catalyst, the supply of electrons to the metal catalyst becomes difficult due to the perovskite-type oxide catalyst having low electron conductivity and the above-described first 2-electron reduction reaction becomes difficult to proceed.

In addition, it is preferable that the metal catalyst be not encaptured or included by the perovskite-type oxide catalyst. This is because, if the metal catalyst is encaptured or included by the perovskite-type oxide catalyst, the supply of oxygen and water necessary for the above-described first 2-electron reduction reaction to the metal catalyst becomes difficult and the above-described first 2-electron reduction reaction becomes difficult to proceed.

In addition, it is preferable that the metal catalyst be located within a predetermined distance from the perovskite-type oxide catalyst. In other words, it is preferable that the shortest distance between the surface of the metal catalyst and the surface of the perovskite-type oxide catalyst be the predetermined distance or less. The predetermined distance is 20 nm, and preferably 10 nm. The metal catalyst and the perovskite-type oxide catalyst may be in contact with each other. In other words, the predetermined distance may be 0 nm. In this manner, since the perovskite-type oxide catalyst and the metal catalyst are in an adjacent state, the reaction intermediate (OOH⁻or the like) produced by the metal catalyst immediately can reach the perovskite-type oxide catalyst to be reduced. In other words, a concerted reaction in which the production reaction of the reaction intermediate by the metal catalyst (above-described first 2-electron reduction reaction) and the reduction reaction of the reaction intermediate by the perovskite-type oxide catalyst (above-described second 2-electron reduction reaction) proceed effectively can be made easy to occur, and the oxygen reduction activity can be improved.

### (Manufacturing Method)

Next, a manufacturing method of the present electrode catalyst will be described. Hereinafter, as one example, the manufacturing method using a citric acid complex method and an impregnation method, in which the perovskite-type oxide catalyst is LaMnO₃ and the metal catalyst is Ag, will be described.

In the manufacturing method of the present electrode catalyst, firstly, metal salts containing La, Mn and O elements and a first solvent are mixed to prepare a first solution. The metal salts containing La, Mn and O elements as raw materials is not particularly limited. Examples of the metal salts include nitrates, acetates, sulfates, carbonates, halides, cyanides and sulfides. Examples of a metal salt containing La include La(NO₃)₃, La(OCOCH₃)₃, La₂(SO₄)₃, La₂(CO₃)₃, LaCl₃, La(CN)₃ and La₂S₃, and examples of a metal salt containing Mn include Mn(NO₃)₂, Mn(OCOCH₃)₂, MnSO₄, MnCO₃, MnCl₂, Mn(CN)₂ and MnS. In addition, the first solvent is not particularly limited. Examples of the first solvent include nitric acid, acetic acid, sulfuric acid, carbonic acid and aqueous solutions thereof. The concentration of the metal salts in the first solution is preferably about 0.05 to 5 M, and more preferably about 0.1 to 1 M.

Next, 0.5 to 10 molar equivalent of citric acid with respect to metal cations in the first solution is dissolved in ethanol, and sufficiently stirred and mixed to prepare a second solution. Citric acid is preferably 1 to 5 molar equivalent, and more preferably 1.5 to 3 molar equivalent. In place of ethanol, 1 to 10 molar equivalent of ethylene glycol with respect to metal cations in the first solution may be used (Pechini method).

Subsequently, the first solution and the second solution are sufficiently mixed at room temperature, and then stirred using a reflux apparatus at 70° C. for 2 hours to form a complex in which citric acid coordinates to the metal salt mixture. After that, a proper amount of carrier carbon is added to the obtained product to be a desired carried amount of the catalyst, and evaporation to dryness is performed. Accordingly, perovskite-type oxide precursor carrier carbon powder is produced.

Next, the produced perovskite-type oxide precursor carrier carbon powder is dried at 120° C., and then crushed by a mortar or the like. Then, the crushed powder is impregnated with a solution in which a predetermined amount of AgNO₃ (another acid salt or a processed object may be used if it contains Ag) is dissolved, evaporation to dryness is performed, and then drying is performed at 120° C.

For the dried powder, air calcination is performed at predetermined temperature and for predetermined time in an electric furnace under an air atmosphere. The predetermined temperature is, for example, more than 150° C. and 250° C. or less. The predetermined temperature is preferably 170° C. or more and 230° C. or less, and more preferably 190° C. or more and 210° C. or less. When the temperature is too low, a LaMnO₃ phase very little is produced and a lot of impurity phases such as a La(OH)₃ phase and a La₂O₃ phase are produced. When the temperature is too high, a lot of the LaMnO₃ phase is produced but the carrier carbon is burned and decreased. The predetermined time is not limited as long as it is 2 hours or more and is about 2 to 10 hours, for example.

After that, heat treatment is performed at predetermined temperature and for predetermined time under an inert atmosphere by an inert heat-treating furnace. The inert atmosphere is an atmosphere where carrier carbon does not burn and is not burned down, and is an inert gas atmosphere such as an Ar atmosphere, for example. In addition, the predetermined temperature is, for example, 500° C. to 900° C., and preferably 600° C. to 800° C. The predetermined time is not limited as long as it is 2 hours or more and is about 2 to 10 hours, for example.

According to the above-described manufacturing method, the present electrode catalyst is formed.

In the above-described manufacturing method of the present electrode catalyst, the above-described perovskite-type oxide precursor carrier carbon powder can be manufactured using a coprecipitation method. For example, a neutralizing agent is dropped into the above-described first solution with a pipette or the like till pH capable of precipitating metal cations to precipitate a metal hydroxide. Then, slurry obtained by the precipitation is water-washed using suction filtration, centrifugation or the like to prepare a precursor. After that, the precursor is impregnated with and supported by carbon to produce perovskite-type oxide precursor carrier carbon powder. Examples of the neutralizing agent include sodium hydroxide and ammonia. An example of pH capable of precipitating metal cations includes pH 12.

The manufacturing method of the present electrode catalyst is not limited to the above-described example, and a conventionally-known method used for synthesis of a catalyst material can be used as long as a desired oxide crystal can be obtained and fine primary particles can be obtained. Examples of such a method include a liquid-phase reduction method, a polymerized complex method, a reverse-micelle method, a sol-gel method, a hydrothermal method, an impregnation method, a solid-phase reaction method and a thermal decomposition method.

Since the electrode catalyst described above includes the perovskite-type oxide catalyst containing La, Mn, and O elements and the metal catalyst containing a Ag element on carrier carbon, the above-described first 2-electron reduction reaction and the above-described second 2-electron reduction reaction can be made to occur effectively and concertedly. Accordingly, the oxygen reduction reaction can be more promoted, and the oxidative decomposition of carrier carbon due to the reaction intermediate can be significantly suppressed. In other words, according to the present embodiment, an electrode catalyst having higher oxygen reduction reaction activity, in which carrier carbon is not oxidatively decomposed in an oxygen reduction reaction, can be obtained.

Hereinafter, an air battery according to the embodiment of the present invention will be specifically described.

### (Air Electrode)

The above-described electrode catalyst is used for an air electrode active material of the air electrode in the air battery. As a method of using the above-described electrode catalyst for the air electrode, for example, a method, in which the electrode catalyst and a binder are physically mixed and the mixture is rolled to form a self-supported film electrode body, can be used.

The binder is not limited. An ion-conducting polymer, such as PTFE (polytetrafluoroethylene) or PVDF (polyvinylidene fluoride), may be suitably used. The added amount of the binder may be arbitrarily adjusted to obtain optimized electrode thickness, oxygen permeability, electron conductivity and ion conductivity and a favorable three-phase interface. The added amount is 5 to 75 mass %, for example.

Alternatively, as another method of using the electrode catalyst for the air electrode of the air battery, for example, a method, in which slurry containing the above-described mixture is applied to an air electrode current collector by an arbitrary application method and then the applied slurry is dried and rolled as needed to form an electrode body, can be used. It is preferable that the surface of the electrode body facing to air be subjected to hydrophobic treatment or the like to prevent liquid leakage of an electrolyte.

As the air electrode current collector, a support, which has oxygen permeability and electron conductivity enough to function as the air electrode of the air battery, for example, a conductive porous body such as foam metal, a metal mesh and carbon paper, and an anion electrolyte film, can be used. Examples of a metal material include stainless steel, aluminum, nickel, iron, and titanium. Examples of a method of applying the slurry to the current collector include a dip coating method, a spray coating method, a roll coating method, a doctor blade method, a gravure coating method and a screen printing method.

### (Anode (Negative Electrode))

An anode includes an anode active material and an anode current collector. Examples of the anode active material include a metal catalyst, an alloy material, and a carbon material. Examples include an alkali metal such as lithium, sodium and potassium, an alkali earth metal such as magnesium and calcium, a group 13 element such as aluminum, a transition metal such as zinc, iron, nickel, titanium and silver, a platinum group element such as platinum, (alloy) materials containing these metals and a carbon material such as graphite. Examples further include an anode material that can be used for a lithium ion battery or the like. In particular, examples of a material containing a metal that can effectively charge and discharge include a hydrogen adsorption alloy such as a AB₅-type rare earth alloy (LaNi₅ or the like) and a BCC alloy (Ti—V or the like) and a metal such as platinum, zinc, iron, aluminum, magnesium, lithium, sodium and cadmium. In particular, zinc is preferable. In addition, examples of a material of the anode current collector include copper, stainless steel, aluminum, nickel, iron, titanium and carbon. In addition, examples of a shape of the anode current collector include a foil shape, a plate shape, and a mesh shape.

For example, when the anode active material has a powder shape, the anode may further contain a conduction auxiliary agent and/or a binder. As the conduction auxiliary agent and the binder, the same materials as carrier carbon and the binder of the above-described air electrode can be used.

### (Electrolyte)

An electrolyte conducts ions between the air electrode and the anode, and a liquid electrolyte, a solid electrolyte, a gel electrolyte, a polymer electrolyte or combinations thereof can be used. As the liquid electrolyte and the gel electrolyte, an aqueous electrolyte and a non-aqueous electrolyte can be used.

Examples of the aqueous electrolyte include an alkali aqueous solution and an acid aqueous solution, and the aqueous electrolyte can be arbitrarily selected depending on the kind of the anode active material. Examples of the alkali aqueous solution include a potassium hydroxide aqueous solution and a sodium hydroxide aqueous solution. Examples of the acid aqueous solution include a hydrochloric acid aqueous solution, a nitric acid aqueous solution, and a sulfuric acid aqueous solution. Among them, as the aqueous electrolyte, a high-alkali aqueous solution is preferable. For example, 8 M KOH is preferable.

Examples of the non-aqueous electrolyte include aprotic organic solvent and ionic liquid. Examples of the organic solvent include a circular carbonate such as propylene carbonate (PC), ethylene carbonate (EC) and fluoroethylene carbonate (FEC), a circular ester such as γ-butyrolactone (GBL), a chain carbonate such as dimethyl carbonate (DMC), diethyl carbonate (DEC) and ethyl methyl carbonate (EMC), and combinations thereof. Examples of the ionic liquid include N,N-diethyl-N-methyl-N-(2-methoxyethyl)ammonium bis(trifluoromethanesulfonyl)amide (DEMETFSA), N-methyl-N-propylpiperidinium bis(trifluoromethanesulfonyl)amide (PP13TFSA) and combinations thereof. In addition, the organic solvent and the ionic liquid may be combined. In addition, a supporting salt may be dissolved in the organic solvent and the ionic liquid. For example, in the case of a lithium air battery, examples of the supporting salt include LiPF₆, LiBF₄, LiN(CF₃SO₂)₂ and LiCF₃SO₃.

The non-aqueous electrolyte can be used in the form of gel by adding a polymer. Examples of a gelation method of the non-aqueous electrolyte include a method in which a polymer such as polyethylene oxide (PEO), polyacrylonitrile (PAN), polyvinylidene fluoride (PVdF) and polymethylmethacrylate (PMMA) is added to the non-aqueous electrolyte.

### (Other Components)

As other components, a separator (not illustrated in the drawings) may be used. The separator is arranged between the above-described air electrode and anode. Examples of a material of the separator include polyethylene and polypropylene porous films. The above-described separator may be a single layer or may be multiple layers. In addition, a known electrode (cathode) used only for charging, such as nickel, may be further included. Charging may be performed by a mechanical charge method.

### (Battery Case)

As a battery case of the air battery, a material usually used for a battery case of an air battery, such as a metal can, a resin and a lamination pack, can be used. In the battery case, a hole for supplying air can be provided at an arbitrary position, which can be provided in the contact surface with air of the air electrode, for example.

The intended use of the present electrode catalyst according to the present embodiment is not limited to the above-described air electrode of the air battery, and the present electrode catalyst can be used for an air electrode of a fuel battery, for example.

### EXAMPLES

Hereinafter, Examples of the present invention will be illustrated. The following Examples are just for illustrative purposes, and do not limit the present invention.

In each of the following Examples and Comparative Examples, measurement of charge-discharge characteristics, ThermoGravimetry-Differential Thermal Analysis (TG-DTA), measurement of X-ray Diffraction (XRD), and measurement of Transmission Electron Microscope (TEM) were performed. Each measurement was performed with the following device.

Measurement device of charge-discharge characteristics: VMP3 manufactured by Bio-Logic Science Instruments

Measurement device of TG-DTA: TG-DTA analysis device manufactured by Rigaku Corporation

Measurement device of XRD: X-ray diffractometer manufactured by Rigaku Corporation

Measurement device of TEM: transmission electron microscope manufactured by JEOL Ltd.

### (I) Evaluation Method of Electrode Catalyst

### Example 1

A sample of Example 1 was an electrode catalyst in which a perovskite-type oxide catalyst composed of LaMnO₃ and a metal catalyst composed of Ag are supported on carbon composed of Ketjenblack.

### (1) Manufacture of Sample

### (1-1) Manufacture of Electrode Catalyst

Firstly, La(NO₃)₃ and Mn(NO₃)₂ as metal salts were dissolved in a nitric acid aqueous solution to prepare a first solution. The concentration of the metal salts in the first solution was 0.5 M. Next, 2 molar equivalent of citric acid with respect to metal cations in the first solution was dissolved in ethanol, and sufficiently stirred and mixed to prepare a second solution. Subsequently, the first solution and the second solution were sufficiently mixed at room temperature, and then stirred using a reflux apparatus at 70° C. for 2 hours to form a complex in which citric acid coordinated to the metal salt mixture. After that, a proper amount of Ketjenblack as a carrier was added to the obtained product, and evaporation to dryness was performed. Accordingly, perovskite-type oxide precursor carrier carbon powder was obtained. Next, the produced perovskite-type oxide precursor carrier carbon powder was dried at 120° C., and then crushed by a mortar or the like. Then, the crushed powder was impregnated with a solution in which a predetermined amount of AgNO₃ was dissolved, evaporation to dryness was performed, and then drying was performed at 120° C. For the dried powder, air calcination was performed at 200° C. in an electric furnace (air atmosphere) while flowing air. After that, heat treatment was performed at 700° C. for 4 hours in an inert heat-treating furnace while Ar flowing. The amounts and concentrations of La(NO₃)₃, Mn(NO₃)₂, AgNO₃, carbon black, and other materials were set such that the carried amount of the perovskite-type oxide catalyst (LaMnO₃) was 45 mass % and the carried amount of the metal catalyst (Ag) was 30 mass % in the present electrode catalyst, respectively. In other words, manufacturing conditions of Example 1 were LaMnO₃: citric acid complex method, Ag: impregnation method, carrier: Ketjenblack, and air calcination temperature: 200° C.

### (1-2) Manufacture of Electrode Body

The above-described present electrode catalyst and PTFE of a binder were physically mixed, and then rolled to manufacture a sheet-like electrode body. The weight ratio of the present electrode catalyst to PTFE is 80:20.

### (2) Evaluation of Sample

### (2-1) Evaluation of Crystallinity

The crystal structure of the electrode catalyst obtained in the above-described (1-1) was measured by XRD. The measurement range of 2θ was from 10° to 90°. The X-ray source is CuKα₁. In addition, the fine structure of the electrode catalyst was measured by TEM.

### (2-2) Evaluation of TG-GTA

TG-GTA was measured during the air calcination while manufacturing the electrode catalyst in the above-described (1-1). The rate of temperature increase is 10° C./min, and the measurement range is from room temperature to 900° C.

### (2-3) Evaluation of Oxygen Reduction Reaction Current

As a method for evaluating the oxygen reduction activity of the electrode body using the electrode catalyst obtained in the above-described (1-2), a CV (Cyclic Voltammetry) measurement method described below was used. The CV measurement method was performed 3 cycles at a scanning rate of 10 mV/sec and in a range from −0.5 V to 0.8 V (vs. Hg/HgO) to measure an oxygen reduction reaction current (ORR current). The electrode body obtained in the above-described (1-2) was used for an air electrode (working electrode), a Pt mesh (2 cm×2 cm) was used for a counter electrode, and a Hg/HgO electrode was used for a reference electrode.

### Example 2

A sample of Example 2 is an electrode catalyst having the same configuration as Example 1. However, Example 2 is different from Example 1 in that LaMnO₃ is manufactured by a coprecipitation method in the manufacturing method. In other words, manufacturing conditions of Example 2 are LaMnO₃: coprecipitation method, Ag: impregnation method, carrier: Ketjenblack, and air calcination temperature: 200° C. Remaining of the manufacture of the sample and the evaluation of the sample are the same as those of Example 1.

### Example 3

A sample of Example 3 is an electrode catalyst having the same configuration as Example 1. However, Example 3 is different from Example 1 in that LaMnO₃ is manufactured by a coprecipitation method and the air calcination temperature is 250° C. in the manufacturing method. In other words, manufacturing conditions of Example 3 are LaMnO₃: coprecipitation method, Ag: impregnation method, carrier: Ketjenblack, and air calcination temperature: 250° C. Remaining of the manufacture of the sample and the evaluation of the sample are the same as those of Example 1.

### Comparative Example 1

A sample of Comparative Example 1 is an electrode catalyst having the same configuration as that of Example 1 except for excluding Ag. In other words, manufacturing conditions of Comparative Example 1 are LaMnO₃: citric acid complex method, carrier: Ketjenblack, and air calcination temperature: 200° C. The remaining manufacture of the sample and the evaluation of the sample are the same as those of Example 1.

### Comparative Example 2

A sample of Comparative Example 2 is an electrode catalyst having the same configuration as that of Example 1 except for excluding LaMnO₃. In other words, manufacturing conditions of Comparative Example 2 are Ag: impregnation method, carrier: Ketjenblack, and air calcination temperature: 200° C. The remaining of the manufacture of the sample and the evaluation of the sample are the same as those of Example 1.

### Comparative Example 3

A sample of Comparative Example 3 is an electrode catalyst having the same configuration as that of Example 1 except for substituting the perovskite-type oxide (LaMnO₃) with a spinel-type oxide (CuCoO₄). In other words, manufacturing conditions of Comparative Example 3 are CuCoO₄: citric acid complex method, Ag: impregnation method, carrier: Ketjenblack, and air calcination temperature: 200° C. The remaining of the manufacture of the sample and the evaluation of the sample are the same as those of Example 1.

### Comparative Example 4

A sample of Comparative Example 4 is an electrode catalyst having the same configuration as that of Example 1 except for substituting the perovskite-type oxide (LaMnO₃) with a spinel-type oxide (Co₃O₄). In other words, manufacturing conditions of Comparative Example 4 are Co₃O₄: citric acid complex method, Ag: impregnation method, carrier: Ketjenblack, and air calcination temperature: 200° C. The remaining of the manufacture of the sample and the evaluation of the sample are the same as those of Example 1.

### (II) Evaluation Result of Samples

The samples and the evaluations of charge and discharge in the above-described respective Examples and Comparative Examples are summarized in Table 1. In Table 1, in the “structure” column, “P” indicates a perovskite-type oxide and “S” indicates a spinel-type oxide.

TABLE 1

| | | | | | | Air | | |
|---|---|---|---|---|---|---|---|---|
| | Oxide | | | Metal | | Calcination | ORR | |
| | | | Manufacturing | | Manufacturing | Temperature | Current | Cycle |
| Sample | Composition | Structure | Method | Composition | Method | T(° C.) | (mA/cm²) | Characteristics |
| Example 1 | LaMnO₃ | P | Citric Acid | Ag | Impregnation | 200 | −103 | ∘ |
| Example 2 | LaMnO₃ | P | Coprecipitation | Ag | Impregnation | 200 | −100 | ∘ |
| Example 3 | LaMnO₃ | P | Coprecipitation | Ag | Impregnation | 250 | −67.4 | ∘ |
| Comparative | LaMnO₃ | P | Citric Acid | — | — | 200 | −91.4 | x |
| Example 1 | | | | | | | | |
| Comparative | — | — | — | Ag | Impregnation | 200 | −60.4 | ∘ |
| Example 2 | | | | | | | | |
| Comparative | CuCoO₄ | S | Citric Acid | Ag | Impregnation | 200 | −0.61 | ∘ |
| Example 3 | | | | | | | | |
| Comparative | Co₃O₄ | S | Citric Acid | Ag | Impregnation | 200 | −0.39 | ∘ |
| Example 4 | | | | | | | | |

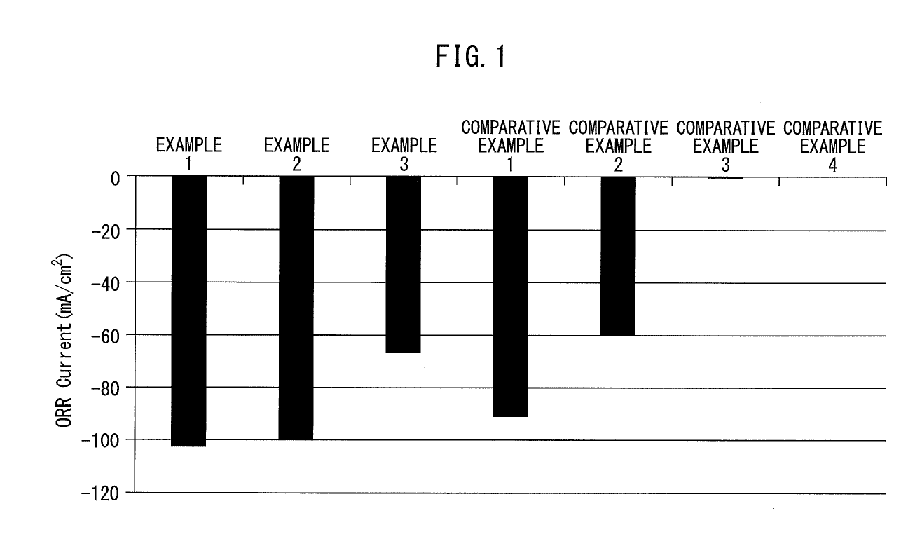

FIG. 1 is a graph illustrating a comparison of oxygen reduction reaction currents (ORR currents) among the evaluations of the samples of the respective Examples and Comparative Examples. Hereinafter, the evaluation results of the respective Examples and Comparative Examples will be described.

### (1) Example 1

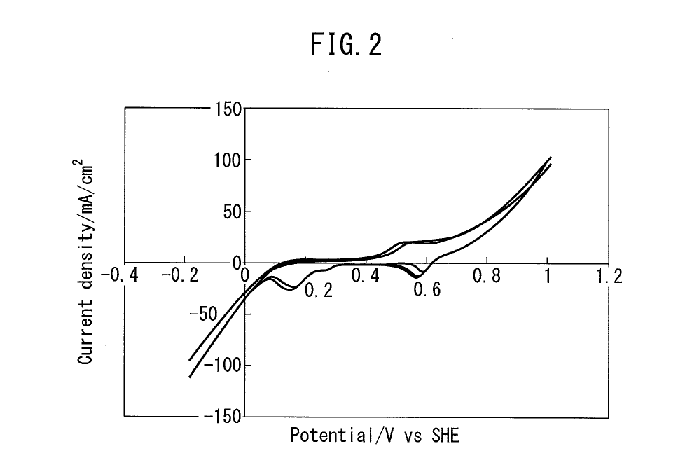

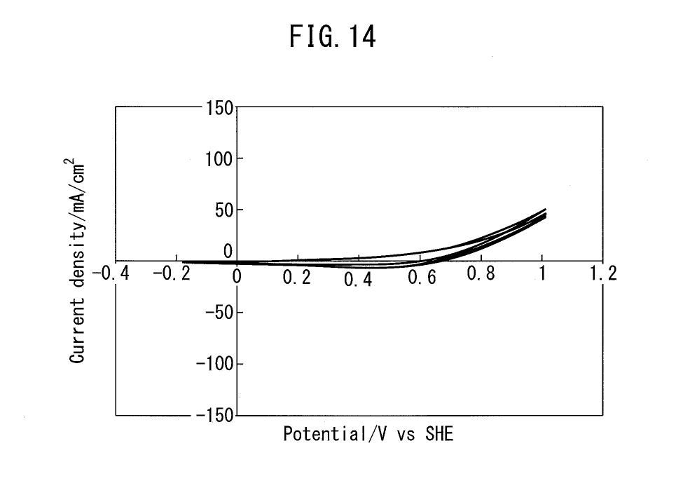

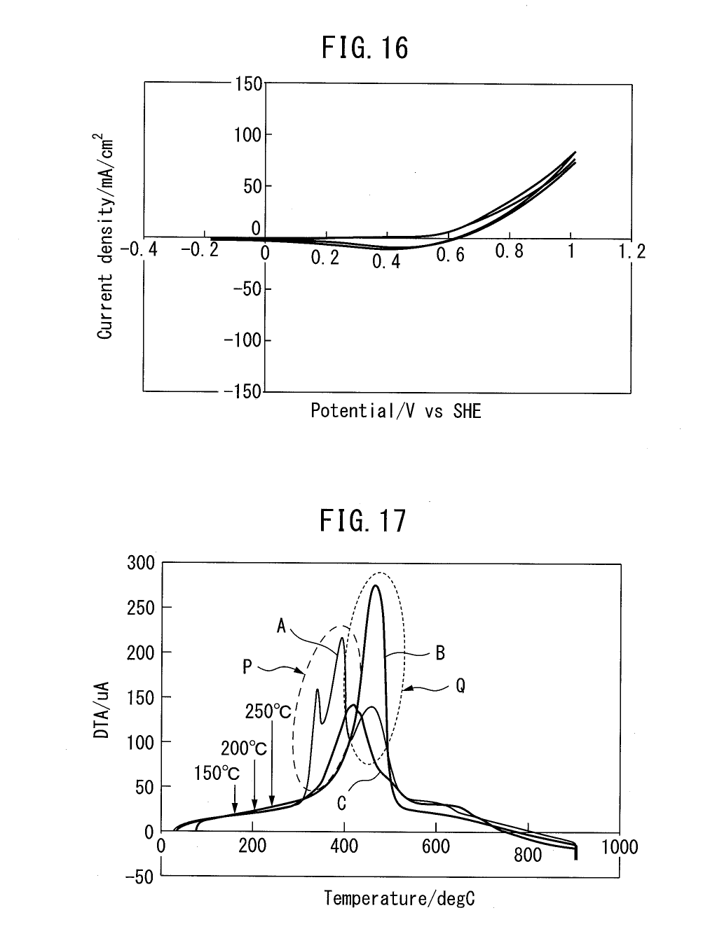

In the electrode catalyst of Example 1, extremely-good oxygen reduction activity was obtained. The details are as follows. FIG. 2 is a graph illustrating a CV measurement result of the electrode catalyst of Example 1. The vertical axis represents a (oxygen reduction reaction) current, and the horizontal axis represents a potential (vs. SHE). In the electrode catalyst of Example 1, an extremely-high oxygen reduction reaction current (−103 mA/cm²) and a high cycle property (difference of oxygen reduction reaction currents between cycles was small) were obtained. The reason is believed to be that the electrode catalyst of Example 1 included the perovskite-type oxide catalyst containing La, Mn and O elements and the metal catalyst containing a Ag element, which were located on the carrier containing C. In contrast, in the electrode catalyst in which the spinel-type oxide such as CuCoO₄ and Co₃O₄ and Ag were supported on carrier carbon of Comparative Examples 3 and 4 as illustrated in FIG. 14 and FIG. 16, only an extremely-low oxygen reduction reaction current (−0.69, −0.39 mA/cm²) was obtained.

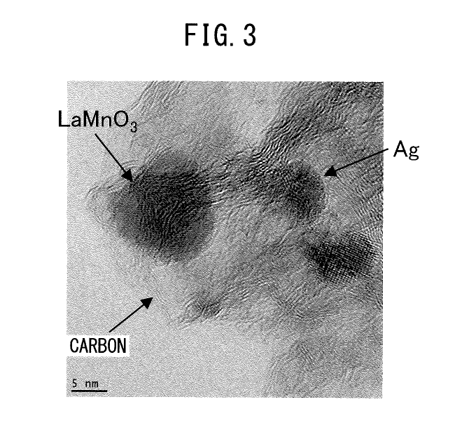

In addition, as another reason, it believed that in the electrode catalyst of Example 1, LaMnO₃ and Ag were located extremely near. FIG. 3 is a photograph illustrating a TEM observation result of the electrode catalyst of Example 1. As illustrated in the drawing, LaMnO₃ and Ag exist closely within a range of 10 nm or less. Accordingly, the reaction intermediate of the above-described first 2-electron reduction reaction that occurs with Ag as a catalyst was effectively supplied to LaMnO₃, and the above-described second 2-electron reduction reaction that occurs with LaMnO₃ as a catalyst is promoted so that high oxygen reduction activity was achieved.

In addition, as another reason, it believed that in the electrode catalyst of Example 1, Ag particles were not encaptured or included by LaMnO₃, as illustrated in FIG. 3. If Ag particles were encaptured or included by LaMnO₃, the first two-electron reduction reaction does not proceed, and thus, the oxygen reduction reaction current is thought to be small.

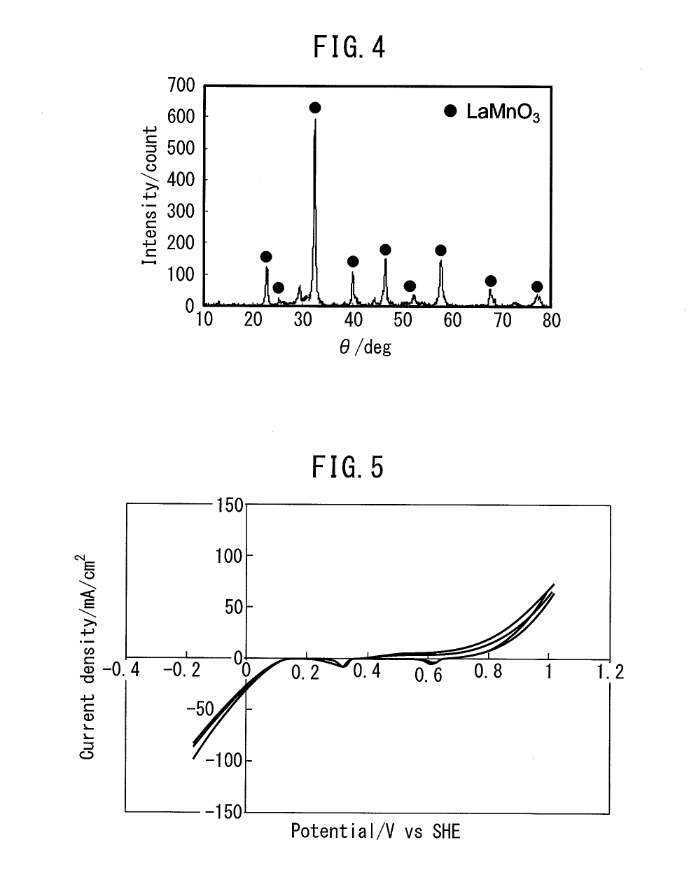

In addition, as another reason, it believed that in the electrode catalyst of Example 1, there were few phases other than LaMnO₃, i.e., there were few impurity phases. FIG. 4 is a diffraction pattern illustrating an XRD measurement result of the electrode catalyst of Example 1. The horizontal axis is a diffraction angle (2θ), and the vertical axis is diffraction intensity. As illustrated in the drawing, it is found that the electrode catalyst of Example 1 was an almost LaMnO₃ single phase. In other words, LaMnO₃ was appropriately crystallized by the air calcination at the time of manufacturing. In addition, as illustrated in FIG. 3, carbon was not burned by the air calcination at the time of manufacturing.

As described above, the above-described electrode catalyst of Example 1 has very good characteristics.

### (2) Example 2

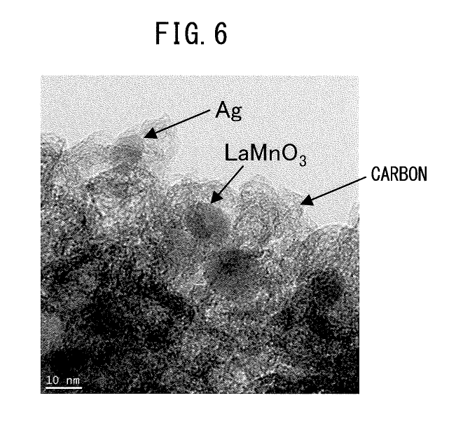

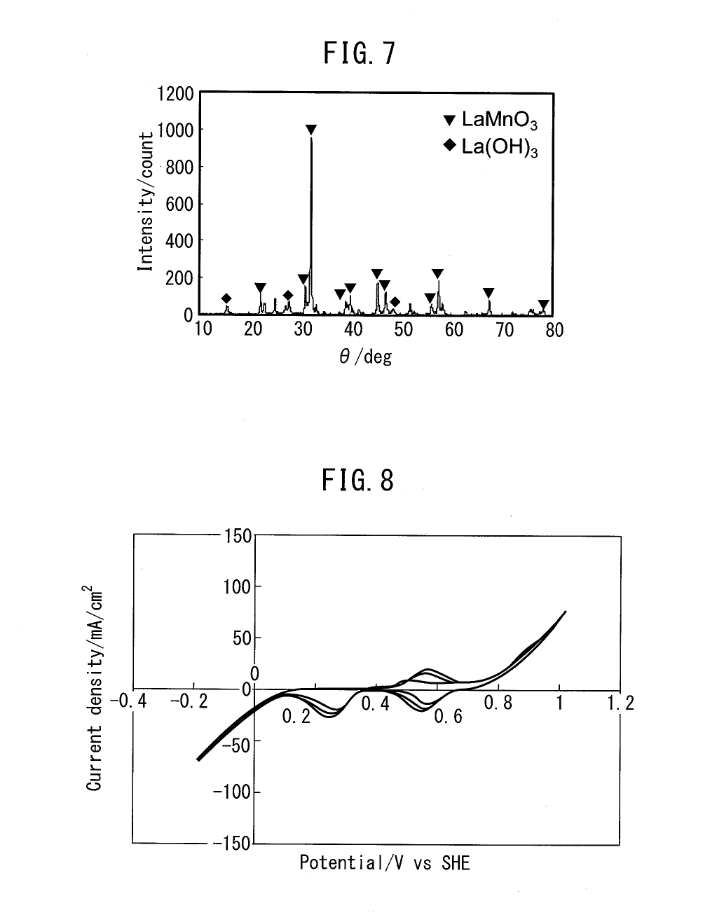

Also in the electrode catalyst of Example 2, extremely-good oxygen reduction activity was obtained. Specifically, in the electrode catalyst of Example 2, as illustrated in a CV measurement result of FIG. 5, an extremely-high oxygen reduction reaction current (−100 mA/cm²) and a high cycle property (difference of oxygen reduction reaction currents between cycles was small) were obtained. The reason is basically the same as the case of Example 1. In other words, this is because the perovskite-type oxide catalyst containing La, Mn, and O elements and the metal catalyst containing a Ag element were included on the C carrier, LaMnO₃ and Ag were located extremely near, for example, within a range of 20 nm or less, as illustrated in a TEM photograph of FIG. 6, Ag was not encaptured or included by LaMnO₃, the most part was a LaMnO₃ phase as illustrated in an XRD measurement result of FIG. 7, and carbon was not burned down by the air calcination at the time of manufacturing.

As described above, the above-described electrode catalyst of Example 2 has very good characteristics.

### (3) Example 3

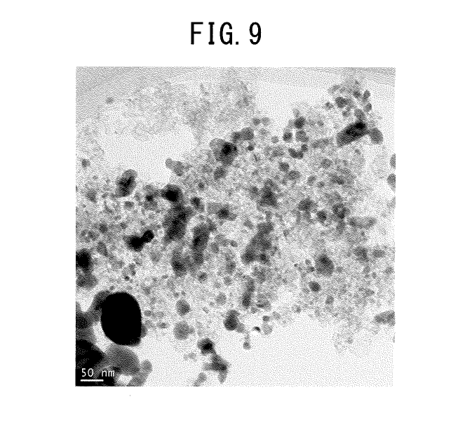

Also in the electrode catalyst of Example 3, good oxygen reduction activity was obtained. Specifically, in the electrode catalyst of Example 3, as illustrated in a CV measurement result of FIG. 8, a high oxygen reduction reaction current (−67.4 mA/cm²) and a high cycle property (difference of oxygen reduction reaction currents between cycles was small) were obtained. The reason is basically the same as the case of Example 1. However, since the air calcination temperature was higher compared with the cases of Examples 1 and 2, the particle diameter tended to become slightly larger due to sintering of LaMnO₃ and carbon tended to be slightly burned down, as illustrated in a TEM photograph of FIG. 9. Accordingly, the ORR current was slightly decreased compared with the electrode catalysts of Examples 1 and 2.

As described above, the above-described electrode catalyst of Example 3 has good characteristics.

### (4) Comparative Example 1

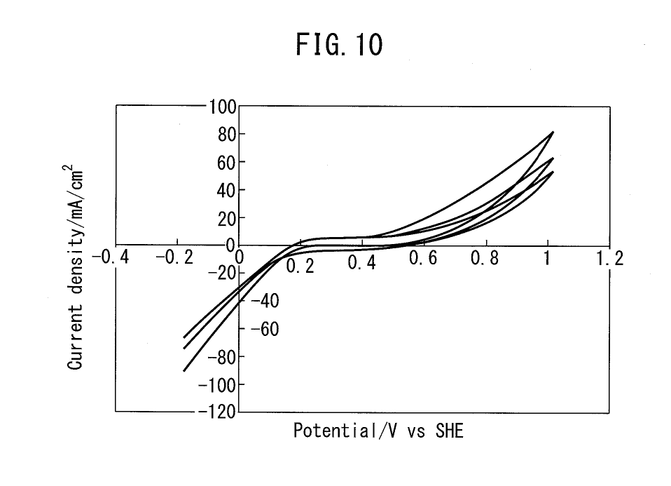

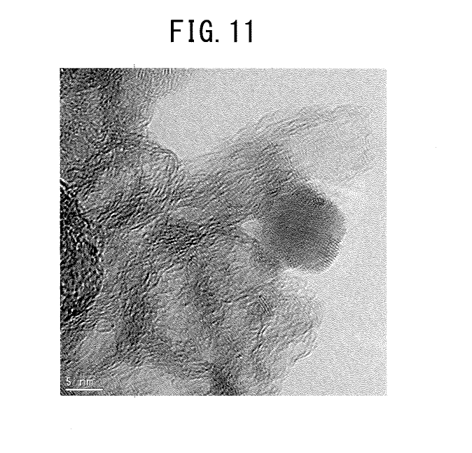

The electrode catalyst of Comparative Example 1 was an electrode catalyst obtained by not adding Ag to the electrode catalyst of Example 1. In the electrode catalyst of Comparative Example 1, as illustrated in a CV measurement result of FIG. 10, the oxygen reduction reaction current was extremely high (−91.4 mA/cm²), but the cycle property was low (difference of oxygen reduction reaction currents between cycles was large). The reason is thought that since fine LaMnO₃ was supported on carrier carbon as illustrated in a TEM photograph of FIG. 11, the electrode catalyst of Comparative Example 1 had initially high oxygen reduction activity but carrier carbon was oxidatively decomposed during oxygen reduction as a charge-discharge cycle proceeded.

### (5) Comparative Example 2

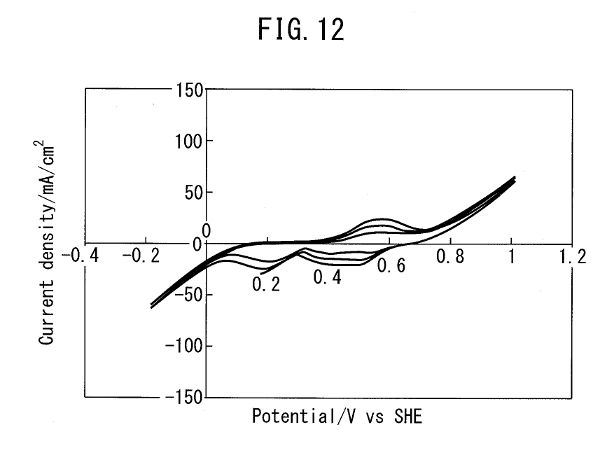

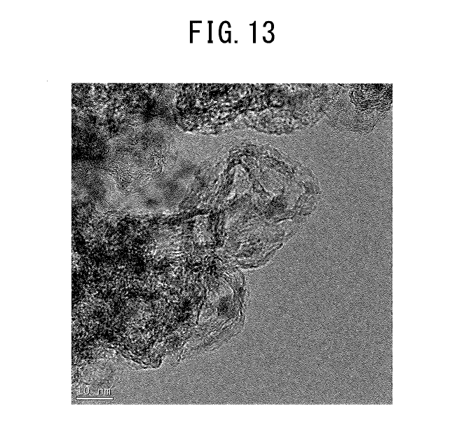

The electrode catalyst of Comparative Example 2 was an electrode catalyst obtained by not having LaMnO₃ in the electrode catalyst of Example 1. In the electrode catalyst of Comparative Example 2, as illustrated in a CV measurement result of FIG. 12, the oxygen reduction reaction current is relatively high (−60.4 mA/cm²), and the cycle property is also high (difference of oxygen reduction reaction currents between cycles was small). The reason is thought that since fine Ag was supported on carrier carbon as illustrated in a TEM photograph of FIG. 13, the electrode catalyst of Comparative Example 2 had high oxygen reduction activity and a relatively-low oxygen reduction reaction current and thus carrier carbon was difficult to be oxidatively decomposed during oxygen reduction.

### (6) Comparative Example 3

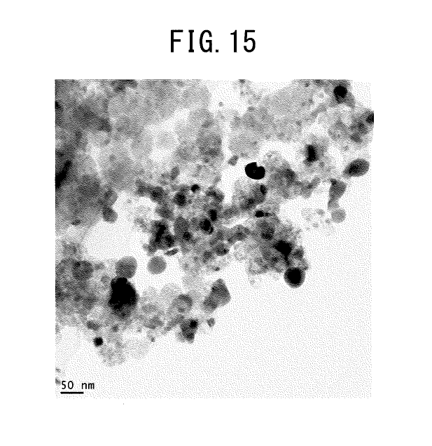

The electrode catalyst of Comparative Example 3 was an electrode catalyst obtained by including a spinel-type oxide CuCoO₄ in place of the perovskite-type oxide LaMnO₃ in the electrode catalyst of Example 1. In the electrode catalyst of Comparative Example 3, as illustrated in a CV measurement result of FIG. 14, the oxygen reduction reaction current was extremely low (−0.61 mA/cm²). In other words, it was found that, even if the electrode catalyst was manufactured by the same method as the manufacturing method of Example 1, when CuCoO₄ was used in place of the perovskite-type oxide LaMnO₃, the oxygen reduction activity was not obtained. The reason is thought that the particle diameter of the spinel-type oxide CuCoO₄ was increased due to sintering as illustrated in a TEM photograph of FIG. 15 and thus the oxygen reduction activity was decreased.

### (7) Comparative Example 4

The electrode catalyst of Comparative Example 4 was an electrode catalyst obtained by including a spinel-type oxide Co₃O₄ in place of the perovskite-type oxide LaMnO₃ in the electrode catalyst of Example 1. In the electrode catalyst of Comparative Example 4, as illustrated in a CV measurement result of FIG. 16, the oxygen reduction reaction current was extremely low (−0.39 mA/cm²). In other words, it was found that, even if the electrode catalyst was manufactured by the same method as the manufacturing method of Example 1, when Co₃O₄ is used in place of the perovskite-type oxide LaMnO₃, the oxygen reduction activity was not obtained. The reason is thought that the particle diameter of the spinel-type oxide Co₃O₄ is increased due to sintering in the same manner as the case of Comparative Example 3 and thus the oxygen reduction activity is decreased.

### (8) Air Combustion Temperature

FIG. 17 is a graph illustrating TG-DTA measurement results by air calcination of Examples and Comparative Examples. The horizontal axis represents sample temperature, and the vertical axis represents a temperature difference between a sample and a reference material. Curved line A, curved line B, and curved line C represent the cases where the precursor is manufactured by the citric acid complex method, the coprecipitation method, and the impregnation method, respectively. A region represented by a dashed line P is a peak derived from combustion of citric acid, and a region represented by a dotted line Q is a peak derived from combustion of carbon. In any manufacturing method of the precursor, the peak generally began from about 300° C. Accordingly, it is found that the air combustion temperature needs to be temperature at least less than 300° C. In addition, from another experiment, it was found that a LaMnO₃ crystal was not sufficiently formed when the air combustion temperature is 150° C. Therefore, it is considered to be appropriate that the air calcination of the precursor is performed within a temperature range of more than 150° C. and 250° C. or less.

What is claimed is:

1. An electrode catalyst comprising:
a C (carbon) carrier;
a perovskite-type oxide catalyst located on the carrier and containing La, Mn, and O elements; and
a metal catalyst located on the carrier and containing a Ag element.

2. The electrode catalyst according to claim 1, wherein the shortest distance between a surface of the metal catalyst and a surface of the perovskite-type oxide catalyst is 20 nm or less.

3. The electrode catalyst according to claim 1, wherein the metal catalyst is not encaptured by the perovskite-type oxide catalyst.

4. The electrode catalyst according to claim 1, wherein the metal catalyst is Ag.

5. The electrode catalyst according to claim 1, wherein the perovskite-type oxide catalyst is LaMnO₃.
